(19) United States
(12) Patent Application Publication
(10) Pub. No.: US 2013/0154355 A1
(43) Pub. Date: Jun. 20, 2013

(54) DEVICE AND METHOD FOR CONTROLLING ENERGY OF VEHICLE ACCORDING TO STORAGE STATE LEVEL

(71) Applicant: Electronics and Telecommunications Research Institute, Daejeon (KR)

(72) Inventors: Yoon Young AN, Daejeon (KR); Chang Min PARK, Daejeon (KR); Wung PARK, Cheongju-si, Chungbuk-do (KR); Pyung Dong CHO, Daejeon (KR)

(73) Assignee: Electronics and Telecommunications Research Institute, Daejeon (KR)

(21) Appl. No.: 13/713,735

(22) Filed: Dec. 13, 2012

(30) Foreign Application Priority Data
Dec. 14, 2011 (KR) 10-2011-0134402

(51) Int. Cl. B60L 1/00

(52) U.S. Cl. CPC B60L 1/00
USPC 307/9.1

(57) ABSTRACT

Provided is an energy controlling method, the method including: determining a charging state level of a battery based on information about a battery state and information about a charging station; generating control information corresponding to the charging state level using a predetermined state table; and transmitting the control information to a vehicle control system associated with a mechanical motion of an electric vehicle, a vehicle multimedia system associated with multimedia apparatuses installed within the electric vehicle, and a service management system associated with a service using a mobile communication network, wherein each of the vehicle control system, the vehicle multimedia system, and the service management system controls a power usage of corresponding apparatuses based on the control information.

### CROSS-REFERENCE TO RELATED APPLICATION

This application claims the priority benefit of Korean Patent Application No. 10-2011-0134402, filed on Dec. 14, 2011, in the Korean Intellectual Property Office, the disclosure of which is incorporated herein by reference.

### BACKGROUND

1. Field of the Invention

The following embodiments of the present invention relate to various systems, such as a vehicle control system, a multimedia control system, and a service management system that are provided within an electric vehicle for vehicle management in association with an electric vehicle and charging system field that is a major field of a smart grid, a structure of an energy management system for controlling an energy usage of devices that are managed by the systems, and an energy management method.

2. Description of the Related Art

An existing in-vehicle management system generally includes a vehicle control system for controlling a device of a vehicle, a multimedia control system for controlling multimedia apparatuses installed within the vehicle, and a service management system for providing a navigation service, a traffic information service, and the like. However, an electric vehicle operates the above installed systems by charging a battery with an electricity. Accordingly, the electric vehicle needs to be distinguished from a vehicle that is driven using an existing fuel such as gasoline, diesel, a liquefied petroleum gas (LPG), and the like.

A petrol station or a gas station that supplies the existing fuel may easily store a fuel. Gas or oil has a high accessibility and prices of gas or oil do not significantly vary. However, a battery technology for storing electric energy has not been greatly developed and the respective electricity charging stations may encounter with different power supply circumstances and thus, prices of electric energy may relatively greatly vary. Accordingly, an electric vehicle may need to manage and control an in-vehicle energy usage.

### SUMMARY

An aspect of the present invention provides a structure of an energy management system that enables an electric vehicle to control an in-vehicle energy usage to be suitable for an available energy state of the vehicle, based on information about a current battery state and information about an available charging station, and an operation method thereof.

According to an aspect of the present invention, there is provided an energy controlling method, the method comprising: determining a charging state level of a battery based on information about a battery state and information about a charging station; generating control information corresponding to the charging state level using a predetermined state table; and transmitting the control information to a vehicle control system associated with a mechanical motion of an electric vehicle, a vehicle multimedia system associated with multimedia apparatuses installed within the electric vehicle, and a service management system associated with a service using a mobile communication network. Each of the vehicle control system, the vehicle multimedia system, and the service management system may control a power usage of corresponding apparatuses based on the control information.

The energy controlling method may further include: receiving information about the charging station; and receiving information about the battery state from a battery management module.

In the predetermined state table, a power usage policy of corresponding apparatuses of each of the vehicle control system, the vehicle multimedia system, and the service management system may be defined with respect to each of a plurality of charging state levels.

In the predetermined state table, any one of power-on or power-off of corresponding apparatuses of each of the vehicle control system, the vehicle multimedia system, and the service management system may be defined with respect to each of the plurality of charging state levels.

Information about the battery state may include information about a currently available battery amount.

Information about the charging station may include at least one of a distance between the electric vehicle and the charging station, information regarding whether the charging station is present in a path between a current position of the electric vehicle and a destination, and information about a charging time at the charging station.

The vehicle control system may manage at least one of an air conditioner, a heater, and an engine motor of the electric vehicle.

The vehicle multimedia system may manage at least one of a radio, an audio player, and a video player.

The service management system may manage an apparatus associated with a navigation service or a traffic information service.

Each of the vehicle control system, the vehicle multimedia system, and the service management system may include an energy control module, and each of the vehicle control system, the vehicle multimedia system, and the service management system may individually control a power usage using the energy control module in response to the control command.

A setting value associated with a speed of the electric vehicle may be controlled based on the charging state level.

According to another aspect of the present invention, there is provided an electric vehicle, comprising: a vehicle control system associated with a mechanical motion of the electric vehicle; a vehicle multimedia system associated with multimedia apparatuses installed within the electric vehicle; a service management system associated with a service using a mobile communication network; a battery to store electric energy; a battery management module to manage the battery; and an energy management system to determine a charging state level of the battery based on information about a battery state and information about a charging station, to generate control information corresponding to the charging state level using a predetermined state table, and to transmit the control information to the vehicle control system, the vehicle multimedia system, and the service management system.

Each of the vehicle control system, the vehicle multimedia system, and the service management system may control a power usage of corresponding apparatuses based on the control information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a network including an electric vehicle charging station management center associated with a vehicle, a traffic information management center, and an electric vehicle charging station according to an embodiment of the present invention;

FIG. 2 is a block diagram illustrating a configuration of an energy control within an electric vehicle according to an embodiment of the present invention;

FIG. 3 is a diagram to describe a method of determining a charging state level in an energy management system according to an embodiment of the present invention;

FIG. 4 is a power control table based on a charging state level in an energy management system according to an embodiment of the present invention; and

FIG. 5 is a vehicle speed control table based on a charging state level in an energy management system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

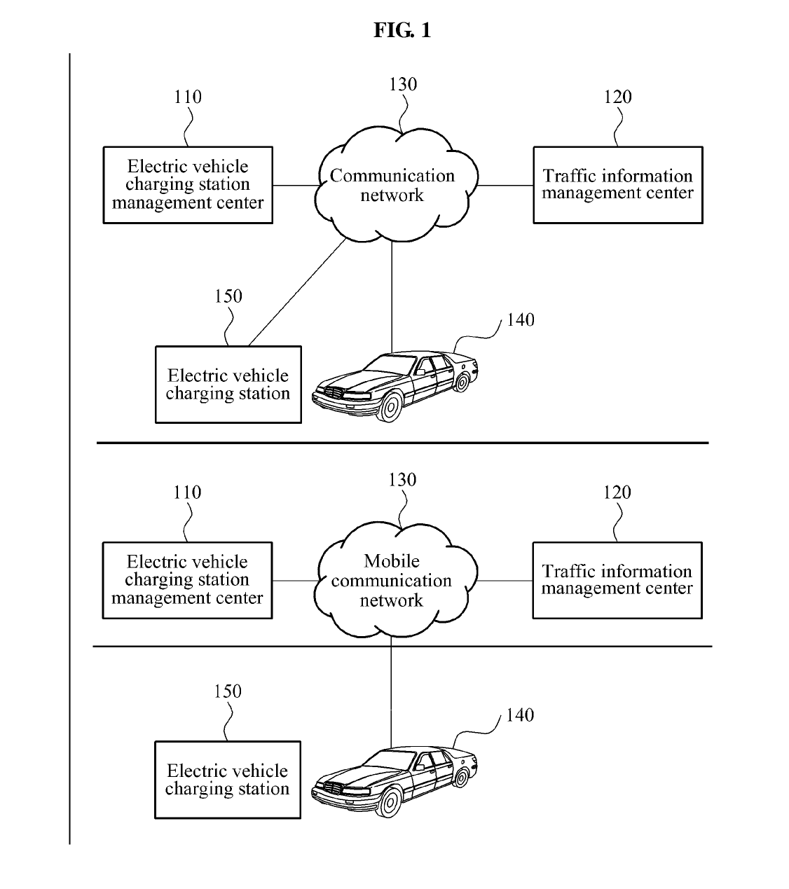

FIG. 1 is a diagram illustrating a network including an electric vehicle charging station management center 110 associated with a vehicle 140, a traffic information management center 120, and an electric vehicle charging station 150 according to an embodiment of the present invention.

As shown in FIG. 1, the vehicle 140 may communicate with the electric vehicle charging station management center 110 and the traffic information management center 120 over a mobile communication network 130. In particular, the electric vehicle charging station management center 110 may inform the vehicle 140 about a position of the electric vehicle charging station 150 close to the vehicle 140, and may also inform the vehicle 140 about prices of electric energy and the like. Also, the traffic information management information center 120 may provide the vehicle 140 with traffic information.

Hereinafter, a further detailed description will be made.

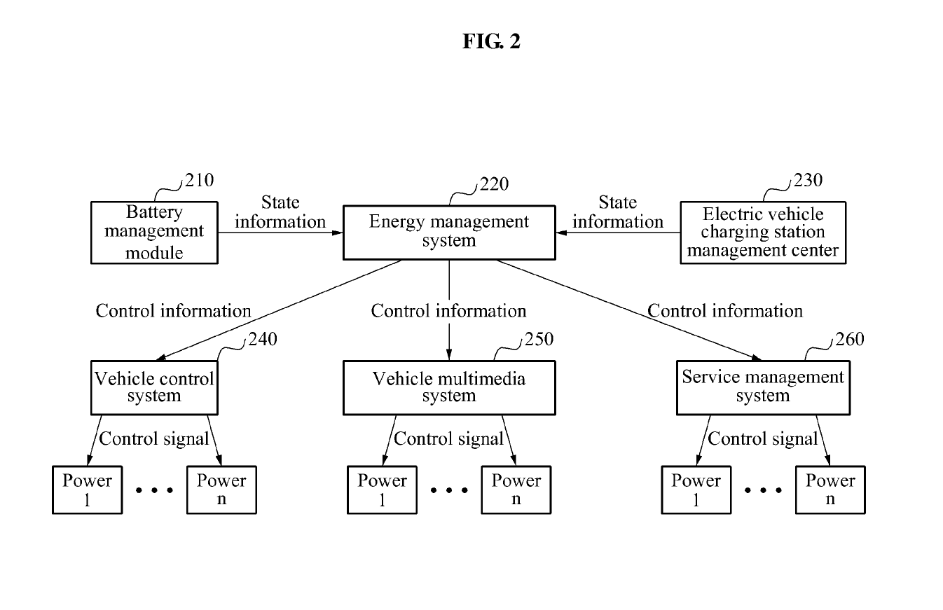

FIG. 2 is a block diagram illustrating a configuration of an energy control within an electric vehicle according to an embodiment of the present invention.

Referring to FIG. 2, a system including the electric vehicle may include an energy management system 220, a battery management module 210 to provide information about a state of available or currently charged energy, an electric vehicle charging station management center 230, a vehicle control system 240 to receive control information about an energy usage, a vehicle multimedia system 250, and a service management system 260.

The vehicle control system 240 may manage power of an engine motor, an air conditioner, a heater, and various apparatuses of the electric vehicle, and may include an energy control module. The vehicle multimedia system 250 may control power of various multimedia apparatuses such as a radio, an MP3 player, a digital multimedia broadcasting (DMB) player, a video player, and the like installed within the electric vehicle, and may include an energy control module. The service management system 260 may include apparatuses for various on-board services such as a navigation service, a traffic information service, and the like, and may exchange information with an external server such as a traffic management center through a mobile communication module such as a wireless code division multiple access (WCDMA), a wireless broadband (WiBbro), long term evolution (LTE), and the like. Also, the service management system 260 may include an energy control module.

The battery management module 210 may transmit information about a battery state to the energy management system 220. The electric vehicle charging station management center 230 may be positioned outside to transmit information about a charging station to the energy management system 220.

Here, information about the battery state may include information about a currently available battery amount. Information about the charging station may include at least one of a distance between the electric vehicle and the charging station, information regarding whether the charging station is present in a path between a current position of the electric vehicle and a destination, and information about a charging time at the charging station.

The energy management system 220 may determine a charging state level of the battery based on information about the battery state and information about the charging station. For example, the energy management system 220 may determine a charging state level of the battery based on a currently available battery amount, a position of the charging station, a charging time, and the like.

For example, when the currently available battery amount is relatively great, but the charging station is positioned to be relatively far, the charging state level may be determined to be high. On the other hand, when the currently available battery amount is relatively small, but the charging station is positioned to be relatively close, the charging state level may be determined to be low.

The energy management system 220 may generate control information corresponding to the charging state level using a predetermined state table.

The vehicle control system 240 may control an energy usage of apparatuses or devices, for example, a room lamp, an air conditioner, a heater, a motor, and the like, installed within the electric vehicle, using the received control information, for example, a charging state level. The vehicle multimedia system 250 may control the energy usage of multimedia apparatuses or devices, for example, a radio, a DMB, an MP3 player, and the like, installed within the electric vehicle using the control information, for example, a charging state level. Also, the service management system 260 may control the energy usage of service apparatuses or devices, for example, a navigation system, and the like, installed within the electric vehicle, using the control information, for example, the charging state level.

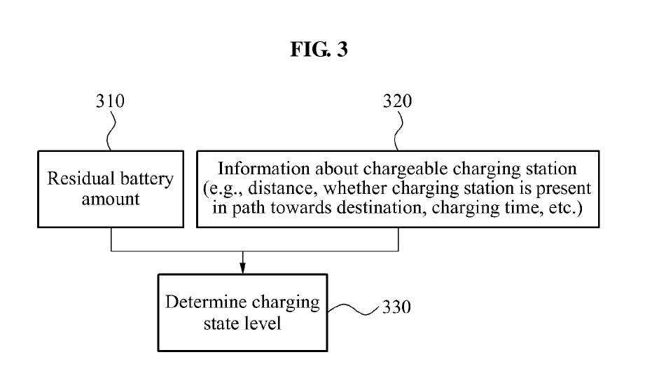

FIG. 3 is a diagram to describe a method of determining a charging state level in an energy management system according to an embodiment of the present invention.

Referring to FIG. 3, in operation 330, the energy management system may determine a charging state level in order to control the energy usage of apparatuses and various systems that consume energy in a vehicle. According to an embodiment of the present invention, to reflect an amount of currently charged energy, and to reflect a residual battery amount 310 and a chargeable battery amount, the charging state level may be determined based on information 320 about an available charging station, for example, a distance between the vehicle and the charging station, information regarding whether the charging station is present in a path towards a destination, a charging time, and the like.

As described above, according to an embodiment of the present invention, a charging state level of a battery may be determined based on a currently available battery amount, a position of a charging station, a charging time, and the like. For example, when the currently available battery amount is relatively great, but the charging station is positioned to be relatively far, the charging state level may be determined to be high. On the other hand, when the currently available battery amount is relatively small, but the charging station is positioned to be relatively close, the charging state level may be determined to be low.

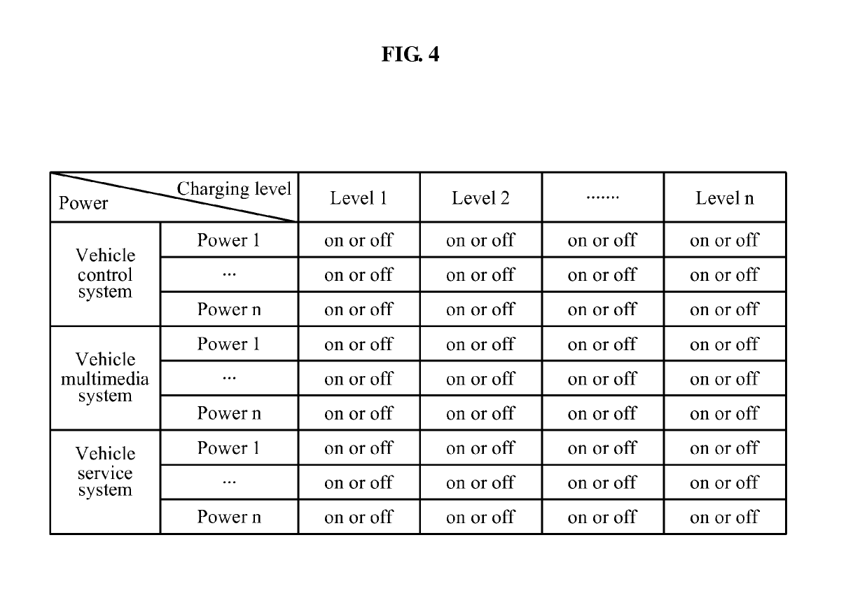

FIG. 4 is a power control table based on a charging state level in an energy management system according to an embodiment of the present invention.

Referring to FIG. 4, in the power control table, a power usage policy of corresponding apparatuses of each of a vehicle control system, a vehicle multimedia system, and a service management system may be defined with respect to each of a plurality of charging state levels.

It is assumed that each of the vehicle control system, the vehicle multimedia system, and a vehicle service system corresponding to the service management system includes n power apparatuses. In this example, in the power control table, power-on or power-off of each of power apparatuses may be defined with respect to each of the plurality of charging state levels.

For example, in a charging state level 1, all the corresponding apparatuses of the vehicle control system may be powered on and only a portion of corresponding apparatuses of the vehicle multimedia system may be powered off. The above example may be variously modified and thereby implemented and thus, a further detailed description will be omitted here.

In response to determining a current charging state level, each of the vehicle multimedia system and the vehicle service system corresponding to the service management system may automatically determine whether to power on or power off n power apparatuses.

Also, each of the vehicle multimedia system and the vehicle service system corresponding to the service management system may include an energy control module, and may control the power usage using the energy control module.

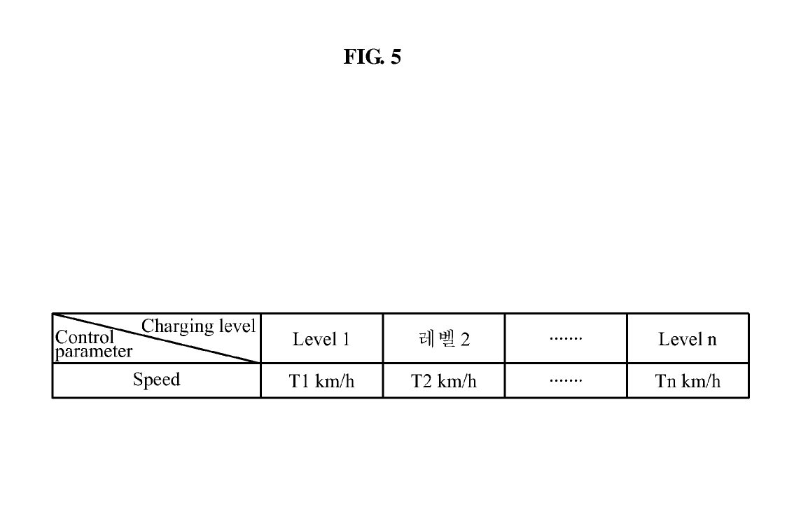

FIG. 5 is a vehicle speed control table based on a charging state level in an energy management system according to an embodiment of the present invention.

Referring to FIG. 5, according to an embodiment of the present invention, a setting value associated with a speed of an electric vehicle may be controlled based on a charging state level. That is, each of a plurality of charging state levels may be mapped with a different speed, and the electric vehicle may easily verify the different speed based on a current charging state level.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to embodiments of the present invention, there is provided a structure of an energy management system that enables an electric vehicle to control an in-vehicle energy usage to be suitable for an available energy state of the vehicle, based on information about a current battery state and information about an available charging station, and an operation method thereof. Therefore, it is possible to enhance the energy usage efficiency in the electric vehicle, and to efficiently operate a charging system.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An energy controlling method, the method comprising:
determining a charging state level of a battery based on information about a battery state and information about a charging station;
generating control information corresponding to the charging state level using a predetermined state table; and
transmitting the control information to a vehicle control system associated with a mechanical motion of an electric vehicle, a vehicle multimedia system associated with multimedia apparatuses installed within the electric vehicle, and a service management system associated with a service using a mobile communication network,
wherein each of the vehicle control system, the vehicle multimedia system, and the service management system controls a power usage of corresponding apparatuses based on the control information.

2. The method of claim 1, further comprising:
receiving information about the charging station; and
receiving information about the battery state from a battery management module.

3. The method of claim 1, wherein, in the predetermined state table, a power usage policy of corresponding apparatuses of each of the vehicle control system, the vehicle multimedia system, and the service management system is defined with respect to each of a plurality of charging state levels.

4. The method of claim 3, wherein, in the predetermined state table, any one of power-on or power-off of corresponding apparatuses of each of the vehicle control system, the vehicle multimedia system, and the service management system is defined with respect to each of the plurality of charging state levels.

5. The method of claim 1, wherein information about the battery state comprises information about a currently available battery amount.

6. The method of claim 1, wherein information about the charging station comprises at least one of a distance between the electric vehicle and the charging station, information regarding whether the charging station is present in a path between a current position of the electric vehicle and a destination, and information about a charging time at the charging station.

7. The method of claim 1, wherein the vehicle control system manages at least one of an air conditioner, a heater, and an engine motor of the electric vehicle.

8. The method of claim 1, wherein the vehicle multimedia system manages at least one of a radio, an audio player, and a video player.

9. The method of claim 1, wherein the service management system manages an apparatus associated with a navigation service or a traffic information service.

10. The method of claim 1, wherein:
each of the vehicle control system, the vehicle multimedia system, and the service management system comprises an energy control module, and
each of the vehicle control system, the vehicle multimedia system, and the service management system individually controls a power usage using the energy control module in response to the control command.

11. The method of claim 1, wherein a setting value associated with a speed of the electric vehicle is controlled based on the charging state level.

12. An electric vehicle, comprising:
a vehicle control system associated with a mechanical motion of the electric vehicle;
a vehicle multimedia system associated with multimedia apparatuses installed within the electric vehicle;
a service management system associated with a service using a mobile communication network;
a battery to store electric energy;
a battery management module to manage the battery; and
an energy management system to determine a charging state level of the battery based on information about a battery state and information about a charging station, to generate control information corresponding to the charging state level using a predetermined state table, and to transmit the control information to the vehicle control system, the vehicle multimedia system, and the service management system,
wherein each of the vehicle control system, the vehicle multimedia system, and the service management system controls a power usage of corresponding apparatuses based on the control information.

13. The electric vehicle of claim 12, wherein, in the predetermined state table, a power usage policy of corresponding apparatuses of each of the vehicle control system, the vehicle multimedia system, and the service management system is defined with respect to each of a plurality of charging state levels.

14. The electric vehicle of claim 13, wherein, in the predetermined state table, any one of power-on or power-off of corresponding apparatuses of each of the vehicle control system, the vehicle multimedia system, and the service management system is defined with respect to each of the plurality of charging state levels.

15. The electric vehicle of claim 12, wherein information about the battery state comprises information about a currently available battery amount.

16. The electric vehicle of claim 12, wherein information about the charging station comprises at least one of a distance between the electric vehicle and the charging station, information regarding whether the charging station is present in a path between a current position of the electric vehicle and a destination, and information about a charging time at the charging station.

17. The electric vehicle of claim 12, wherein:
each of the vehicle control system, the vehicle multimedia system, and the service management system comprises an energy control module, and
each of the vehicle control system, the vehicle multimedia system, and the service management system individually controls a power usage using the energy control module in response to the control command.
